(19) United States
(12) Patent Application Publication
(10) Pub. No.: US 2024/0028235 A1
(43) Pub. Date: Jan. 25, 2024

(54) NEURAL NETWORK MEMORY CONFIGURATION

(71) Applicants: ECS Partners Limited, Southampton (GB); Arm Limited, Cambridge (GB)

(72) Inventors: Sulaiman Sadiq, Reading (GB); Jonathon Hare, Southampton (GB); Geoffrey Merrett, Southampton (GB); Partha Prasun Maji, Cambridge (GB); Simon John Craske, Cambridge (GB)

(21) Appl. No.: 17/813,396

(22) Filed: Jul. 19, 2022

(51) Int. Cl. G06F 3/06

(52) U.S. Cl. CPC G06F 3/0644; G06F 3/0604; G06F 3/0673

(57) ABSTRACT

Briefly, embodiments, such as methods and/or systems for employing external memory devices in the execution of activation function such as activation functions implemented in a neural network. In one aspect, a first activation input tensor may be partitioned as a plurality of tensor segments stored in one or more external memory devices. Individual stored tensor segments may be sequentially loaded to memories local to processing circuitry to apply activation functions associated with the stored tensor segments.

### BACKGROUND

### 1. Field

This disclosure relates to memory transactions to enable execution of inference operations.

### 2. Information

Neural Networks (NNs) have found success in a variety of applications including, for example, image classification and natural language understanding, just to mention a couple of examples. Additionally, Internet of things (IoT) devices are increasingly prevalent in commerce with projections for over 40 billion connected IoT devices by 2025. This has led to the development of the field of Tiny Machine Learning (TinyML) which aims to develop models and frameworks suitable for performing inference operations locally on an IoT device. Such inference operations performed locally on an IoT device may enable a number of applications directed to smart homes and cities, health analytics, and industrial sensing, just to provide a few examples.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a neural network formed in “layers”, according to an embodiment;

FIG. 2 is an illustration of performance envelopes of alternative processing architectures according to an embodiment;

FIG. 3 is a schematic diagram of a memory architecture for a processing element according to an embodiment;

FIG. 4 is a schematic diagram of a processing layer to perform convolution operations, according to an embodiment;

FIG. 5 is a schematic diagram of a processing layer to perform addition operations, according to an embodiment;

FIG. 6 is a schematic diagram illustrating a processing stack according to an embodiment;

FIG. 7 is a schematic diagram of a feature map according to an embodiment;

FIG. 8 is a flow diagram of a process to process an activation input tensor according to an embodiment; and

FIG. 9 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

According to an embodiment, a neural network may comprise a graph comprising nodes to model neurons in a brain. In this context, a “neural network” as referred to herein means an architecture of a processing device defined and/or represented by a graph including nodes to represent neurons that process input signals to generate output signals, and edges connecting the nodes to represent input and/or output signal paths between and/or among the artificial neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neuron may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

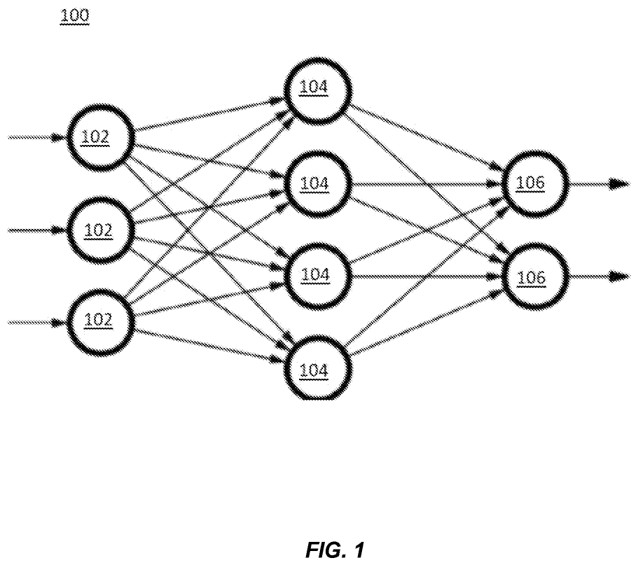

FIG. 1 is a schematic diagram of a neural network 100 formed in “layers” in which an initial layer is formed by nodes 102 and a final layer is formed by nodes 106. Neural network (NN) 100 also includes an intermediate layer formed by nodes 104. Edges shown between nodes 102 and 104 illustrate signal flow from an initial layer to an intermediate layer. Likewise, edges shown between nodes 104 and 106 illustrate signal flow from an intermediate layer to a final layer. While neural network 100 shows a single intermediate layer formed by nodes 104, it should be understood that other implementations of a neural network may include multiple intermediate layers formed between an initial layer and a final layer.

According to an embodiment, a node 102, 104 and/or 106 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ back propagation techniques to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation.

In a particular implementation, neural network-based machine learning may be implemented in devices with a small processing footprint such as an IoT device. Such IoT devices may be configured for local execution of inference operations enabled to be implemented by Tiny Machine Learning (TinyML) for applications such as smart homes and cities, health analytics, and industrial sensing. Nonetheless, implementations of TinyML devices and products face some challenges. One such challenge relates to resource constraints of microcontrollers to be implemented in IoT devices. Such IoT devices have limited memory, a relatively small (if any) cache, and have a singular processor core to execute operations. Modern graphics processing units (GPUs), however, may have orders of magnitude larger memory and multiple cores to facilitate parallel processing. As such, improvements in efficiency of limited resource usage in IoT devices are desirable.

Some solutions to implement TinyML in resource-constrained devices may take a simplified view of microcontroller architectures by considering only internal memory. While such approaches may incrementally improve on previous implementations, these approaches may nonetheless fall short of yielding satisfactory performance for both accuracy and latency. This may arise, at least in part, from a lack of high performing architectures in a small space of architectures that can be deployed within the limitations of available internal memory. To facilitate improved accuracy, such devices may implement a higher class of devices, such as devices based on the STM32F4 (256 KB cache, 1 MB SRAM) device to STM32H7 (512 KB cache, 2 MB SRAM) device, in order to alleviate memory constraints. Suboptimal approaches to utilization of microcontrollers may limit the performance of deep learning on resource constrained devices.

In one example aspect, an approach to implementing TinyML may employ an expanded and accelerated approach to implement ImageNet classification. A space of deployable architectures may be expanded by taking a holistic view of a microcontroller architecture. In an implementation, external memory interfaces may enable supplementing a limited internal memory (e.g., static random access memory (SRAM)) and non-volatile storage (e.g., flash) with inexpensive external memory (e.g., synchronous dynamic random access memory (SDRAM)) and/or non-volatile (e.g., NOR flash). While larger pools of external memory resources may enable architectures to provide increased accuracy, external memory resources may inject higher inference latencies.

Briefly, one implementation is directed to a method of loading activation input values to an inference engine implemented as one or more neural networks in a device (e.g., an IoT device). In one aspect, an activation input tensor stored in one or more external memory devices may be partitioned into a plurality of tensor segments. Direct memory access (DMA) transactions may sequentially load individual tensor segments of the stored activation input tensor to memories local to processing circuitry for application of activation functions associated with the tensor segments. Application of DMA transactions to sequentially load partitioned tensor segments of a stored activation input tensor to such memories local to processing circuitry may enable reduction in inference latency in high accuracy architectures that employ external memories. This may enable microcontroller resources to leverage slower external memory in combination with higher speed of internal memory.

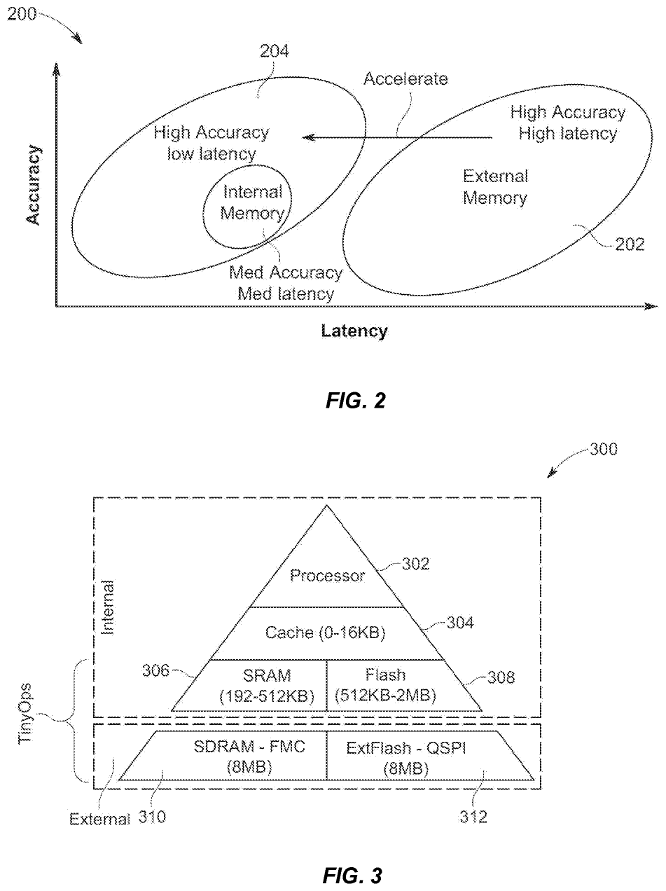

FIG. 2 shows performance plots of alternative inference operation architectures based on accuracy and latency, according to an embodiment. Plot 202 represents an operational envelope of a first architecture configured for high accuracy by leveraging large external memory resources. Plot 204 represents an operational envelope of a second architecture that also leverages large external memory resources. However, the second architecture may also apply DMA transactions to sequentially load partitioned tensor segments of a stored activation input tensor to local processor memories to reduce latency without degrading accuracy. Particular implementations of a second architecture represented by plot 204 may recognize that it is not necessary that all input parameters be loaded to internal memory (e.g., SRAM). Latency may then be reduced without degrading accuracy by partitioning larger operations into multiple independent smaller operations that meet internal memory size constraints. For example, a second architecture represented by plot 204 may use external memories as main memory and overlay frequently accessed data, such as input tensors, weights etc. in SRAM to reduce latency without degrading accuracy. According to an embodiment, an architecture represented by plot 204 may partition a large operation (e.g., activation function) in an inference graph into multiple, smaller operations to reduce SRAM memory usage, enabling accurate inference results while meeting an internal memory budget. In a particular implementation, on-chip DMA peripheral circuitry may independently maintain a memory overlay in parallel with internal memory local to a processing element. This may, for example, enable the processing element to process input parameters in an inference pipeline to enhance throughput.

FIG. 3 is a schematic diagram of a memory architecture 300 for a processing element according to an embodiment. In a particular implementation, memory architecture 300 may be applied in execution of an activation function at a node of a neural network, for example. In a particular implementation, processor 302 may comprise circuitry and an instruction set consistent with a Cortex® processor developed by Arm Limited. It should be understood, however, that different types of processor circuitry may be used to implement processor 302, and that claimed subject matter is not limited in this respect. As shown, input values to be processed by processor 302, and output values to be produced by processor 302 may be stored in one or more memories having different associated sizes and access latencies. Cache 304 having a smallest size may be associated with a lowest access latency. External memories SDRAM 310 and external flash 312, on the other hand, may have a largest size and a highest access latency.

According to an embodiment, cache 304, SRAM 306 and flash 308 may collectively comprise internal memory devices formed on the same physical device (e.g., integrated circuit (IC) die) as processor 302. As shown, SDRAM 310 and external flash 312 may comprise devices that are external to a physical device on which processor 302, cache 304, SRAM 306 and flash 308 are formed. SDRAM 310 and external flash 312 may be coupled a device including processor 302, cache 304, SRAM 306 and flash 308 through a memory bus (e.g., Serial Peripheral Interface (SPI), not shown). Such a memory bus may enable direct memory access (DMA) transactions to facilitate writing parameters and/or values stored in SDRAM 306 and/or external flash 312 to SRAM 306 and/or flash 308 independently of a host processor (not shown). Likewise, such a memory bus may enable DMA transactions writing parameters and/or values stored in SRAM 306 and/or flash 308 to SDRAM 306 and/or external flash 312. In this context, “direct memory access” as referred to herein means a process executed by one or more hardware subsystems to access a main system memory independently of a host processing unit and/or central processing unit (CPU). Such a DMA transaction may be trigged by a signal, condition and/or event (e.g., interrupt signal). In the particular implementation of memory architecture 300, for example, a DMA transaction may be executed by specialized circuitry such as a DMA controller (not shown) positioned on a bus coupling external memory SDRAM and external flash 312 to internal memory SRAM 306 and Flash 308. In a particular implementation, processor 302, cache 304, SRAM 306 and flash 308 may be integrated into a single microcontroller unit (MCU) that is coupled to SDRAM 310 and/or external flash by a memory bus as described above. In this context, a “microcontroller unit” as referred to herein means an integrated circuit device having a non-volatile memory, a processor unit to execute instructions stored on the non-volatile memory and one or more built-in communication and/or peripheral devices. As discussed herein, particular embodiments are directed to exploiting an availability of memory devices external to an MCU to complement internal memories while mitigating impact of latencies associated with access such memory devices external to the MCU.

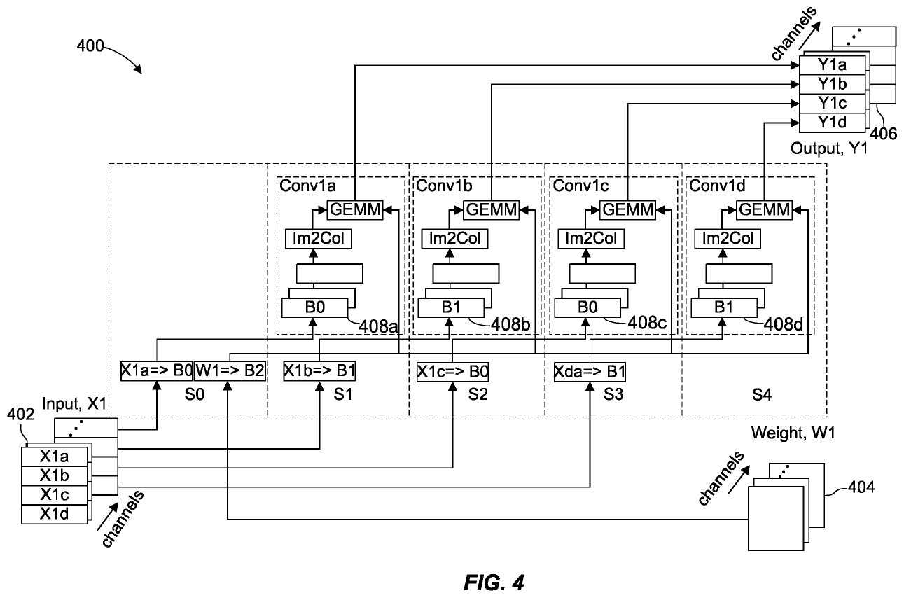

FIG. 4 is a schematic diagram of a processing layer 400 to perform convolution operations, according to an embodiment. In a particular implementation, processing layer 400 may implement activation functions as part of a neural network as convolution operations executed at an initial layer of the neural network (e.g., initial layer formed by nodes 102, FIG. 1). In particular implementations, features of processing layer 400 may be implemented at an input layer, an output layer and/or an intermediate layer of a neural network. According to an embodiment, convolution operations Conv1a, Conv1b, Conv1c and Conv1d may be performed by computing circuitry formed at least in part as an MCU according to memory architecture 300, for example. Here, weights 404 (e.g., associated with NN nodes and/or edges) may be stored in external memory and loaded to a local processor for application to an activation input tensor X1. According to an embodiment, activation input tensor X1 may be stored in an external memory 402 (e.g., SDRAM 310 and/or external flash 312), and sequentially loaded in segments X1a, X1b, X1c and X1d to be processed in convolution operations Cony1a, Cony1b, Conv1c and Conv1d. Computation results of Conv1a, Conv1b, Conv1c and Conv1 d may be stored in external memory 406 as output values results Y1a, Y1b, Y1c and Y1d, respectively. Output values results Y1a, Y1b, Y1c and Y1d may then be supplied as input values for processing in a subsequent neural network layer of processing, for example.

According to an embodiment, activation input tensor X1 may comprise a multidimensional array stored in contiguous or non-contiguous locations in one or more external memory devices. Given limited internal memory resources, it may not be possible or desirable to have such limited internal memory resources store an entirety of activation input tensor X1 at once. As such, in an embodiment, activation input tensor X1 may be partitioned into smaller tensor segments X1a, X1b, X1c and X1d in external memory to be sequentially loaded to internal memory in DMA transactions, one segment at a time. For example, tensor segment X1a may be loaded via a first DMA transaction to a buffer 408a formed in internal memory to be subsequently copied to cache (e.g., 304) and/or processor registers. While tensor segment X1a copied to cache and/or processor registers is being processed in convolution operation Conv1a, tensor segment X1b may be loaded via a second DMA transaction to a buffer 408b formed in internal memory load to be subsequently copied to cache and/or registers. Similarly, while tensor segment X1b copied to cache and/or processor registers is being processed in convolution operation Conv1b, tensor segment X1c may be loaded via a third DMA transaction to a buffer 408c formed in internal memory load to be subsequently copied to cache and/or processor registers. Likewise, while tensor segment X1c copied to cache and/or processor registers is being processed in convolution operation Conv1c, tensor segments X1d may be loaded via a fourth DMA transaction to a buffer 408d formed in internal memory load to be subsequently copied to cache and/or processor registers.

According to an embodiment, weights W1 stored in external memory 404 may be loaded to an internal memory prior to application in convolution operations Conv1a, Conv1b, Conv1c and Conv1d. In a particular alternative implementation, weights W1 stored in external memory 404 may be partitioned to correspond to convolution operations Conv1a, Conv1b, Conv1c and Conv1 d to process sequentially loaded tensor segments X1a, X1b, X1c and X1d, respectively. For example, four segments of weights W1 may be loaded in four DMA transactions for application in respective associated convolution operations Conv1a, Conv1b, Conv1c and Conv1d.

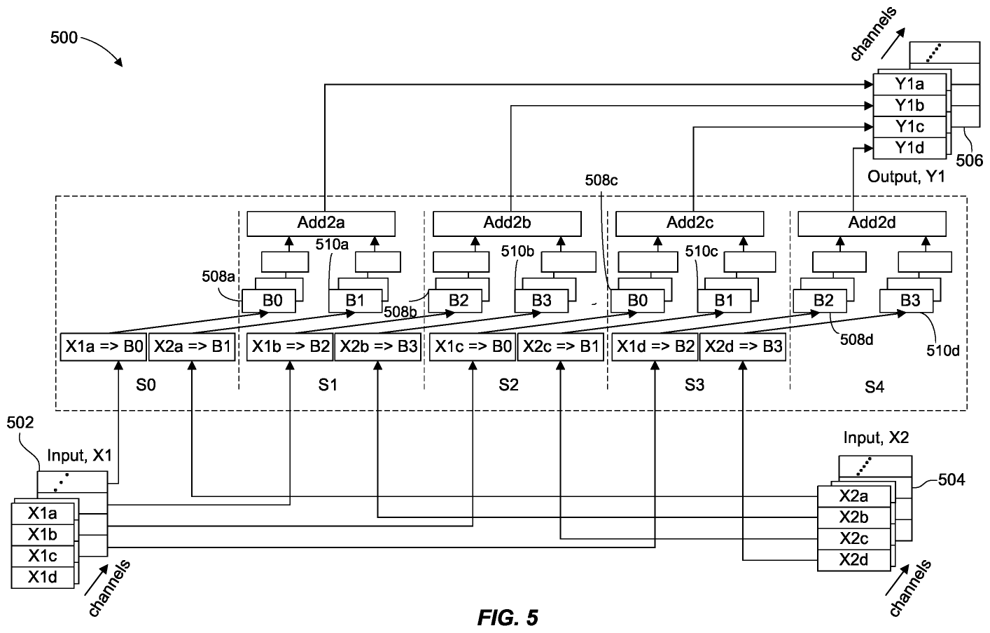

FIG. 5 is a schematic diagram of a processing layer 500 to perform addition operations, according to an alternative embodiment. In a particular implementation, processing layer 500 may execute activation functions as part of a neural network as addition operations performed at an initial input layer, intermediate layer and/or output layer of the neural network (e.g., initial layer formed by nodes 102, FIG. 1). According to an embodiment, addition operations Add2a, Add2b, Add2c and Add2d may be performed by computing circuitry formed according to at least in part as an MCU memory architecture 300, for example. Here, portions of activation input tensor X1 stored in external memory 502 (e.g., SDRAM 310 and/or external flash 312) may be additively combined with portions of activation input tensor X2 stored in external memory 504 (e.g., SDRAM 310 and/or external flash 312). Results of addition operations Add2a, Add2b, Add2c and Add2d may be stored in external memory 506 as output values results Y1a, Y1b, Y1c and Y1d, respectively. Output values results Y1a, Y1b, Y1c and Y1d may then be supplied as input values for processing in a subsequent neural network layer of processing, for example.

According to an embodiment, activation input tensors X1 and X2 may each comprise a multidimensional array stored in contiguous or non-contiguous locations in one or more external memory devices. Given limited internal memory resources, it may not be possible or desirable to have such limited internal memory resources store an entirety of activation input tensor X1 and/or X2 at once. As such, in an embodiment, activation input tensor X1 may be partitioned into smaller tensor segments X1a, X1b, X1c and X1d in external memory to be sequentially loaded to internal memory in DMA transactions, one segment at a time. Similarly, activation input tensor X2 may be partitioned into smaller tensor segments X2a, X2b, X2c and X2d to be sequentially loaded to internal memory in DMA transactions, one tensor segment at a time. For example, tensor segments X1a and X2a may be loaded via first DMA transactions to buffers 508a and 510a formed in internal memory to be subsequently copied to cache (e.g., 304) and/or processor registers. While tensor segments X1a and X2a copied to cache and/or processor registers are being processed in addition operation Add2a, tensor segments X1b and X2b may be loaded via second DMA transactions to buffers 508b and 510b formed in internal memory to be subsequently copied to cache and/or registers. Similarly, while tensor segments X1b and X2b copied to cache and/or processor registers one being processed in addition operation Add2b, tensor segments X1c and X2c may be loaded via third DMA transactions to buffers 508c and 510c formed in internal memory load to be subsequently copied to cache and/or processor registers. Likewise, while tensor segments X1c and X2c copied to cache and/or processor registers are being processed in addition operation Add2c, tensor segments X1d and X2d may be loaded via fourth DMA transactions to buffers 508d and 510d formed in internal memory load to be subsequently copied to cache and/or processor registers.

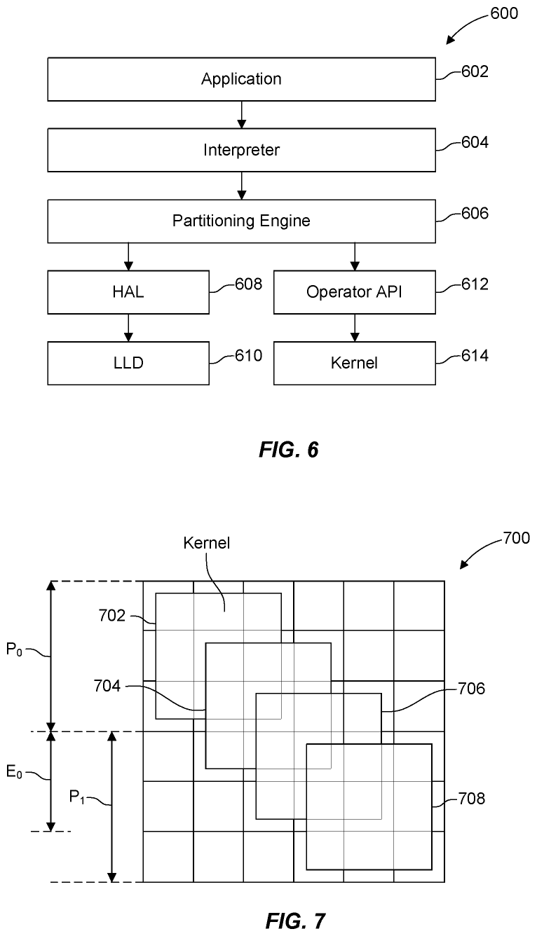

According to an embodiment, processing layer 400 and/or 500 may be implemented in combination with a CPU/host processing platform to, for example, execute applications that supply activation input tensors and use prediction results. For example, such a CPU/host processing platform may define a system memory that is read and/or write accessible (e.g., SDRAM 310 and/or external flash 312). FIG. 6 is a schematic diagram illustrating processing layers 600 hosted on such a CPU/host processing platform according to an embodiment. Application instructions to implement layer 602 may be interpreted for execution by processing at layer 604. Responsive to application processes defined in layer 606, a partitioning engine implemented by layer 606 may partition activation input tensors into tensor segments to be stored in external memory and provided as inputs to activation functions (e.g., activation functions associated with nodes of a neural network layer). In the particular implementation of processing layer 400 as shown in FIG. 4, for example, such a partitioning engine may partition an activation input tensor X1 into tensor segments X1a, X1b, X1c and X1d to be sequentially loaded to internal memory in host-initiated memory transactions and/or DMA transactions (e.g., operations initiated at or controlled by a DMA controller independently of CPU/host processing platform executing applications), one segment at a time, for associated convolution operations. It should be understood, however, that these are merely examples of how a tensor segments may be loaded from an external memory to an internal memory, and claimed subject matter is not limited in this respect. Similarly, in the particular implementation of processing layer 500 shown in FIG. 5, such a partitioning engine may partition multiple activation input tensors X1 and X2 into tensor segments X1a, X1b, X1c, X1d, X2a, X2b, X2c and X2d to be sequentially loaded to internal memory in DMA transactions for associated addition operations.

According to an embodiment, a partitioning engine in layer 606 may initiate operations to partition an activation input tensor with a large SRAM requirement into smaller tensor segments responsive to calls from an interpreter at layer 604. In an implementation, smaller tensor segments resulting from such a partitioning may be sufficiently small to be contained in size-constrained but fast internal SRAM (e.g., SRAM 306). With such a reduction in peak SRAM usage, activation input tensors for inference operations may be copied from external memory (e.g., SDRAM 310) to internal memory (e.g., SRAM 306) for faster inference operations. As pointed out above, copying of partitioned activation input tensors may be offloaded to circuitry to execute DMA transactions independently and in parallel with execution of the host/CPU computing platform. Implementing a ping-pong buffering technique as discussed above in reference to FIGS. 4 and 5, for example, a partitioning engine at layer 606 may establish a pipeline between a DMA controller and processors to execute activation functions to enable efficient execution of an inference operation (e.g., at processing layer 400 and/or 500). While processors execute an initial block (e.g., initial tensor segment), a DMA controller may prepare a subsequent block (e.g., subsequent tensor segment) by copying from external memory (e.g., SDRAM 310) to internal memory (e.g., SRAM 306). Synchronization of a processor to execute an activation function and DMA controller in such a pipelined execution may be maintained via a light-weight interrupt-based queuing mechanism, for example. After finishing processing of one block (e.g., tensor segment), a processor may release a first buffer and commence processing a subsequent block which has been readied by a DMA controller, which commences to load a third block into the newly released buffer, and so on. In an embodiment, operations with reduced peak SRAM usage may be sequentially executed in this manner until an inference operation has been completed.

According to an embodiment, parameters and/or values making up activation input tensors (e.g., activation input tensor X1 and/or X2) may be stored in external memory in an NHWC format, for example. In an implementation, a partitioning engine at layer 606 may partition an activation input tensor stored in external memory at a tensor allocation time. For example, tensor segments (e.g., tensor segments X1a, X1b, X1c, X1d, X2a, X2b, X2c and X2d) may be created by partitioning an activation input tensor stored in an NHWC format tensor along an H-dimension.

According to an embodiment, an activation function may comprise convolving an activation input tensor with coefficients of a kernel using operations such as, for example, Pooling, Cony or DepConv, just to provide a few examples. In one particular implementation, application of a kernel in such a convolution operation may span multiple operations to process multiple associated tensor segments (e.g., memory at a tensor allocation time). For example, coefficients of a kernel may be applied across multiple tensor segments (e.g., tensor segments X1a, X1b, X1c and X1d) partitioned from an activation input tensor (e.g., X1). As shown in FIG. 7, a 6×6 tensor may be partitioned into multiple tensor segments to be convolved with a 3×3 kernel in two associated processor operations. The first three rows Po may comprise a first partition and the subsequent three rows Pi comprise a second partition.

According to an embodiment, a partitioning engine at layer 606 may optimize execution of pipelined for inference operations in a neural network. During execution of a current operation, a partitioning engine may employ a look-ahead process to initiate transfers of tensor segments to internal memory via a DMA transaction in advance for a subsequent operations as shown in FIGS. 4 and 5. This may enable establishment of a network level pipeline synchronized to reduce and/or eliminate overhead of a single slot prolog and epilog in the pipelined execution of an operation.

In a particular implementation, use of internal memory resources (e.g., SRAM 306) for read and write operations may be optimized for executing inference operations. As may be observed, some values and/or parameters stored in internal memory may be accessed with greater frequency than other values and/or parameters stored in internal memory. In the particular implementation of FIG. 4, for example, for numerous read accesses of tensor segments X1 and weights to be applied in performing convolution operations, there may be only a single write operation to external memory (e.g., SDRAM 310) to output tensor Y1 since intermediate results may be accumulated on-chip. Taking advantage of this observation, internal memory (e.g., SRAM 306) may not necessarily be used for output tensors. Additionally, tensor structures and other sparsely accessed metadata to characterize an inference graph may be stored in external memory (e.g., SDRAM 310) to reduce use of internal memory (e.g., SRAM 306).

According to an embodiment, a processing layer for executing activation functions (e.g., processing layers 400 and 500 of FIGS. 4 and 5) may employ different numbers of buffers for different types of operations. As shown in processing layer 400, for example, a ping-pong buffering technique may employ two buffers for an operation to process a single tensor segment. As shown in processing layer 500, for example, a ping-pong buffering technique may employ four buffers for an operation to process two tensor segments. According to an embodiment, utilization of allocated SRAM buffers may be increased by overlaying filters and biases of one-input parametric operations (Cony, DepConv) from external memory in the otherwise unused buffers. Additionally, particular implementations may take advantage of a reduced SRAM usage to overlay frequently accessed quantization parameters as well. This overlaying may be performed via DMA transactions using a smart look-ahead strategy synchronized at an operation level to optimize pipelining by copying filter coefficients in advance. By using pre-emptive scheduling between multiple DMA streams, multiple overlays may be achieved using only a single DMA controller, freeing resources to be available for other workloads. As shown in FIG. 4, for example, filter overlaying may be performed on a lower priority stream while DMA transactions may load parameters for higher priority pipeline operations pipeline, preempting DMA transactions to load parameters for lower priority operations. In a particular case where all buffers are occupied by an operation, execution may stall pipeline operations until buffers are freed.

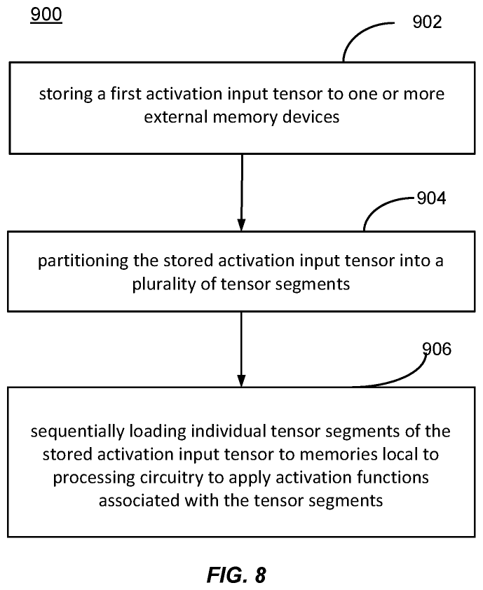

FIG. 8 is a flow diagram of a 900 process to execute operations to store activation input tensor to memory for processing by one or more activation functions, according to an embodiment. In a particular implementation, process 900 may be initiated and/or be at least partially controlled by processing layers 600 (FIG. 6). At block 902, an activation input tensor may be loaded to one or more external memory devices. Such an activation input tensor may comprise activation input tensor X1 as shown in FIG. 4. In an alternative implementation, a second activation input tensor, such as activation input tensor X2 as shown in FIG. 5, may also be stored in one or more external memory devices.

Block 904 may comprise partitioning an activation input tensor stored in one or more external memory devices into multiple tensor segments. For example, block 904 may be performed, at least in part, by processed controlled by layer 606 to partition activation input segment X1 into tensor segments X1a, X1b, X1c and X1d. In an alternative implementation, a second activation input tensor stored in one or more external memory devices, such as activation input tensor X2, may also be partitioned into multiple tensor segments. Block 606 may comprise execution of DMA transactions to sequentially load tensor segments partitioned at block 604 to an internal memory for application of activation functions associated with the tensor segments. In a particular implementation, one more buffers may be formed in such an internal memory to facilitate a ping-pong buffering technique such that while a processor is applying an activation to one tensor segment stored in internal memory, a DMA transaction may load a subsequent tensor segment to a buffer in internal memory as described with reference to FIGS. 4 and 5.

In the context of process 600, terms “external memory device” and “internal memory” may be distinguished in their application to different portions of a computing apparatus including a processor to execute operations of an activation function. In one aspect, parameter and/or values stored in such an external memory device may be copied and or loaded to an internal memory prior to application of the stored parameter and/or values being an operand of an operation executed by an associated processor. In one particular implementation, parameters and/or values stored in an external memory device may be copied and/or loaded to an internal memory via a DMA transaction as described above. In another implementation, an external memory device may be coupled to internal memory by a bus that is configured to executed read and/or write operations between internal and external memories according a protocol. In yet another implementation, an internal memory may be formed on the same IC die as a processor to execute operations while such an external memory device may be formed on a different device distinct from the IC die.

According to an embodiment memory architecture 300, processing layer 400 and/or processing layer 500 may be formed by and/or expressed in transistors and/or lower metal interconnects (not shown) in processes (e.g., front end-of-line and/or back-end-of-line processes) such as processes to form complementary metal oxide semiconductor (CMOS) circuitry, just as an example. It should be understood, however that this is merely an example of how circuitry may be formed in a device in a front end-of-line process, and claimed subject matter is not limited in this respect.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

If received within a computer system via one or more machine-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process (e.g., wafer fabrication process).

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter. Rather, it is asserted, that physical measurements are not mental steps and, likewise, are not abstract ideas.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

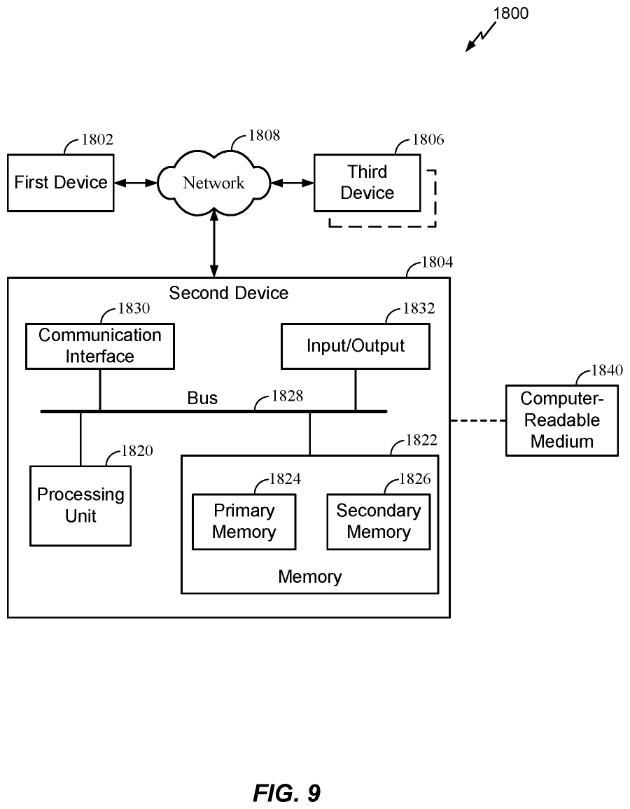

Example devices in FIG. 9 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 and 4 through 8, and in the text associated with the foregoing figure(s) of the present patent application.

In an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 9, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 9, is merely one example, and claimed subject matter is not limited in scope to this particular example. FIG. 9 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

Computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 9 also illustrates device 1804 as including a component 1832 operable with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
storing a first activation input tensor to one or more first storage devices;
partitioning the stored first activation input tensor into a plurality of tensor segments;
sequentially loading individual tensor segments of the stored activation input tensor to one or more second storage devices, the one or more second storage devices being integrated in a microcontroller unit (MCU) with processing circuitry to apply one or more activation functions associated with the tensor segments.

2. The method of claim 1, wherein sequentially loading individual first tensor segments of the stored first activation input tensor further comprises:
loading a first tensor segment of the individual tensor segments to a first portion of the one or more second storage devices local to processing circuitry to apply a first activation function to the first tensor segment of the individual tensor segments; and
completing of loading of a second tensor segment to a second portion of the one or more second storage devices local to the processing circuitry to apply the first activation function subsequent to commencement of application of the first activation function to the first tensor segment.

3. The method of claim 1, and further comprising:
storing weights in at least one of the one or more first storage devices;
partitioning the stored weights according to the one or more activation functions; and
sequentially loading individual stored weights to the storage devices local to the processing circuitry to apply the one or more activation functions.

4. The method of claim 3, wherein at least one of the one or more activation functions comprises a dot product.

5. The method of claim 1, and further comprising:
storing a second activation input tensor to at least one of the one or more first storage devices;
partitioning the stored second activation input tensor into a plurality of second tensor segments; and
sequentially loading individual second tensor segments of the stored activation input tensor to the one or more second storage devices to processing circuitry to apply at least one of the one or more activation functions associated with the tensor segments.

6. The method of claim 5, wherein at least one of the one or more activation functions comprises an operation to additively combine an associated tensor segment of the plurality of tensor segments and an associated tensor segment of the plurality of second tensor segments.

7. The method of claim 1, wherein the one or more first storage devices are external to the MCU.

8. The method of claim 1, wherein sequentially loading individual tensor segments of the stored activation input tensor to memories local to processing circuitry comprises executing a sequence of first direct memory access (DMA).

9. A computing device, the computing device comprising:
one or more first storage devices to store a first activation input tensor;
circuitry to partition the stored activation input tensor into a plurality of tensor segments;
a microcontroller unit (MCU) coupled to the one or more first storage devices, the MCU comprising one or more second storage devices and processing circuitry to apply one or more activation functions associated with the plurality of tensor segments;
and
circuitry to sequentially load individual tensor segments of the stored activation input tensor to the one or more second storage devices.

10. The computing device of claim 9, wherein:
the one or more first storage devices comprise at a dynamic random access memory (DRAM) device or a flash memory device, or a combination thereof; and
the one or more second storage devices comprise at least one static random access memory (SRAM) device.

11. The computing device of claim 9, wherein the circuitry to sequentially load individual tensor segments of the stored first activation input tensor comprises one or more direct memory access (DMA) controllers.

12. The computing device of claim 9, and further comprising:
storing weights in at least one of the one or more first storage devices;
partitioning the stored weights according to the one or more activation functions; and
sequentially loading individual stored weights to the one or more second storage devices.

13. The computing device of claim 9, and further comprising a memory bus coupled to the MCU to transfer tensor segments and/or weights between the one or more first storage devices and the one or more second storage devices.

14. The computing device of claim 13, wherein the memory bus comprises a Serial Peripheral Interface (SPI).

15. An article comprising:
a non-transitory storage medium comprising computer-readable instructions stored thereon that are executable by one or more processors of a computing device to:
express a microcontroller unit (MCU), to be formed in a circuit device, to be coupled to one or more first storage devices, the MCU to comprise one or more second storage devices and processing circuitry to apply activation functions associated with at least one activation input tensor stored in the one or more first storage devices;
express circuitry, to be formed in the circuit device, to partition the stored activation input tensor into a plurality of tensor segments; and
express circuitry, to be formed in the circuit device, to sequentially load individual tensor segments of the stored activation input tensor to the one or more second storage devices.

16. The article of claim 15, wherein the circuitry to sequentially load individual tensor segments of the stored activation input tensor comprises one or more direct memory access (DMA) controllers.

17. The article of claim 15, wherein the instructions are further executable by the one or more processors of the computing device to:
express circuitry, to be formed in the circuit device, comprising a memory bus coupled to the MCU to transfer tensor segments and/or weights between the one or more first storage devices and the one or more second storage devices.

18. The computing device of claim 17, wherein the memory bus comprises a Serial Peripheral Interface (SPI).
